(19) United States
(12) Patent Application Publication
(10) Pub. No.: US 2024/0013597 A1
(43) Pub. Date: Jan. 11, 2024

(54) AUTHENTICATION METHOD AND APPARATUS FOR GATE ENTRANCE

(71) Applicant: CUBOX CO, LTD., Seoul (KR)

(72) Inventor: Un Sung NAM, Seoul (KR)

(73) Assignee: CUBOX CO, LTD., Seoul (KR)

(21) Appl. No.: 18/023,925

(22) PCT Filed: Mar. 5, 2021
(86) PCT No.: PCT/KR2021/002771

§ 371 Date: Feb. 28, 2023

(30) Foreign Application Priority Data
Aug. 31, 2020 (KR) 10-2020-0110270

(51) Int. Cl. G07C 9/00

(52) U.S. Cl. CPC G07C 9/00563

(57) ABSTRACT

There is provided a method of authenticating gate access. The method includes: identifying, by a user terminal, gate devices provided in a plurality of gates using a beacon; performing, by the user terminal, authentication using biometric information stored in advance and transmitting a result of the authentication to an authentication server; checking, by the user terminal, a location of a specific gate for which access authorization is given among the plurality of gates; receiving, by the authentication server, the result of the authentication and checking whether access of a user of the user terminal is allowed; and transmitting, by the user terminal, a control signal to a gate device provided in the specific gate according to whether the access is allowed.

### CROSS-REFERENCE TO PRIOR APPLICATIONS

This application is a National Stage patent application of PCT International Patent Application No. PCT/KR2021/002771 (filed on Mar. 5, 2021) under 35 U.S.C. § 371, which claims priority to Korean Patent Application No. 10-2020-0110270 (filed on Aug. 31, 2020), which are all hereby incorporated by reference in their entirety.

### BACKGROUND

The following disclosure relates to a method and terminal for performing authentication for gate access using a user biometric information-based template.

The human body has various pieces of biometric information, such as a fingerprint, speech, a face, an iris, and a vein, and since biometric information is unique information, authentication technology using biometric information is widely used. In particular, in the case of airports, government offices, and business offices that need to strictly restrict access for safety management, access authentication technology using biometric information, such as fingerprints, have come into wide use.

Such an authentication technology that uses biometric information has initially used information acquired by bringing a part of the body into contact with a sensing device, such as fingerprint or iris, but the acquired information has a high inaccuracy, and people have aversion to the sensing device, which is used by a plurality of users, for reasons of hygiene. Accordingly, recently, there is an increasing use of authentication technology that uses biometric information acquired in a non-contact manner, such as a face image.

On the other hand, biometric information extracted from a specific site of a body is converted into data for use. The data is called a template, and a user is authenticated using a method of comparing a pre-registered template with a template extracted in the field. However, the technology allows biometric information of users to be stored in a server regardless of the user's intention, which violates the biometric information protection guidelines.

### SUMMARY

Therefore, it is an object of the disclosure to provide a method and terminal for dually performing authentication for gate access using a user biometric information-based template.

In one general aspect, there is provided a method of authenticating gate access, the method including: identifying, by a user terminal, gate devices provided in a plurality of gates using a beacon; performing, by the user terminal, authentication using biometric information stored in advance and transmitting a result of the authentication to an authentication server; checking, by the user terminal, a location of a specific gate for which access authorization is given among the plurality of gates; receiving, by the authentication server, the result of the authentication and checking whether access of a user of the user terminal is allowed; and transmitting, by the user terminal, a control signal to a gate device provided in the specific gate according to whether the access is allowed.

In another general aspect, there is provided a method of authenticating gate access, the method including: receiving, by a user terminal, a beacon from at least one of a plurality of gate devices provided in a plurality of gates; in response to the beacon being received, activating, by the user terminal, an application to capture a face image of a user, generating a temporary template on the basis of the face image, and comparing the temporary template with an authentication template stored in advance to perform authentication; checking, by the user terminal, a location of a specific gate, for which access authorization is given among the plurality of gates, according to a result of the authentication; transmitting, by the user terminal, the result of the authentication and information about the access authorization to the authentication server; checking, by the authentication server, whether access of a user of the user terminal is allowed on the basis of the result of the authentication; and transmitting, by the authentication server, a control signal to the specific gate according to a result of the checking of whether access is allowed and the information about the access authorization.

In yet another general aspect, there is provided a method of authenticating gate access, the method including: transmitting, by a user terminal, a beacon to some gate devices of a plurality of gate devices provided in a plurality of gates, the some gate devices being located within an area in which short-range wireless communication is available; driving, by a specific gate device located most adjacent to the user terminal among the some gate devices, a camera according to the beacon to capture a face image of a user; receiving, by the authentication server, the face image from the specific gate device, and comparing the face image with pieces of biometric information of a plurality of users registered in a database to perform authentication, and checking whether access of the user is allowed according to a result of the authentication; receiving, by the user terminal, a response indicating the result of the authentication and information about whether the access is allowed from the authentication server, and checking a location of a specific gate for which access authorization is given among the plurality of gates; and transmitting, by the user terminal, a control signal to a gate device provided in the specific gate.

In yet another general aspect, there is provided a method of authenticating gate access, the method including: transmitting, by a user terminal, a beacon to some gate devices among a plurality of gate devices provided in a plurality of gates, the some gate devices being located within an area in which short-range wireless communication is available; driving, by a specific gate device located most adjacent to the user terminal among the some gate devices, a camera according to the beacon to capture a face image of a user; generating, by the specific gate device, a temporary template using the face image of the user, and comparing the temporary template with a plurality of authentication templates generated on the basis of pieces of biometric information stored in advance to perform authentication; receiving, by an authentication server, a result of the authentication from the specific gate device to check whether access of the user is allowed; receiving, by the user terminal, a response indicating the result of the authentication and information about whether access of the user is allowed from the authentication server, and checking a location of a specific gate for which access authorization is given among the plurality of gates; and transmitting, by the user terminal, a control signal to a gate device provided in the specific gate.

In yet another general aspect, there is provided an apparatus for authenticating gate access, the apparatus including: a Bluetooth module configured to transmit a beacon at equal intervals to detect a user terminal that approaches an area in which communication is available; a camera configured to, in response to a user of the user terminal approaching an area in which capture is performable, capture a face image of the user; an authentication module configured to generate a template on the basis of the face image and compare the template with a plurality of templates of a plurality of users stored in advance to perform authentication on the user; and a gate control module configured to open a gate according to a result of the authentication received from the authentication module.

Embodiments of the present disclosure may have effects including the following advantages. However, since it does not mean that the embodiments of the present disclosure should include all of the effects, the scope of the present disclosure should not be construed as being limited thereby.

According to one embodiment of the present disclosure, the method and apparatus for authenticating gate access can allow user's gate access to be rapidly and accurately processed through biometric information-based double authentication.

In addition, since biometric information of a user for which authentication is completed is not stored, the biometric information protection guidelines can be observed.

In addition, since there is no need to make a separate input or touch on a body part for gate access, the convenience of the authentication process can be increased.

### BRIEF DESCRIPTION OF THE DRAWINGS

FIG. 1 is a diagram illustrating a method of authenticating gate access based on a user terminal according to an embodiment of the present disclosure.

FIG. 2 is a diagram illustrating a method of authenticating gate access based on an authentication server according to an embodiment of the present disclosure.

FIG. 3 is a diagram illustrating a method of authenticating gate access based on a gate device and an authentication server according to an embodiment of the present disclosure.

FIG. 4 is a diagram illustrating a method of authenticating gate access based on a gate device according to an embodiment of the present disclosure.

FIG. 5 is a diagram illustrating an apparatus for authenticating gate access according to an embodiment of the present disclosure.

FIG. 6 is a diagram illustrating a gate device provided in a gate.

### DETAILED DESCRIPTION

While the present disclosure is subject to various modifications and alternative embodiments, specific embodiments thereof are shown by way of example in the accompanying drawings and will be described. However, it should be understood that there is no intention to limit the present disclosure to the particular embodiments disclosed, but on the contrary, the present disclosure is to cover all modifications, equivalents, and alternatives falling within the spirit and scope of the present disclosure.

It will be understood that, although the terms first, second, A, B, etc. may be used herein to describe various elements, the elements should not be limited by the terms. The terms are only used to distinguish one element from another. For example, a first element could be termed a second element, and similarly, a second element could be termed a first element without departing from the scope of the present disclosure. As used herein, the term “and/or” includes any one or combination of a plurality of the associated listed items.

As used herein, the singular forms “a” and “an” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components but do not preclude the presence or addition of one or more other features, integers, steps, operations, elements, components, and/or groups thereof.

Prior to describing the drawing in detail, it should be noted that a division of the configuration units in the specification is intended for ease of description and divided only by the main function set for each configuration unit. That is, two or more of the configuration units to be described hereinafter may be combined into a single configuration unit or formed by two or more of divisions by function into more than a single configuration unit.

Furthermore, each of the configuration units to be described hereinafter may additionally perform a part or all of the functions among functions set for other configuration units other than being responsible for the main function, and a part of the functions among the main functions set for each of the configuration units may be exclusively taken and certainly performed by other configuration units. Therefore, the existence of the configuration units that are each described through the specification needs to be functionally interpreted.

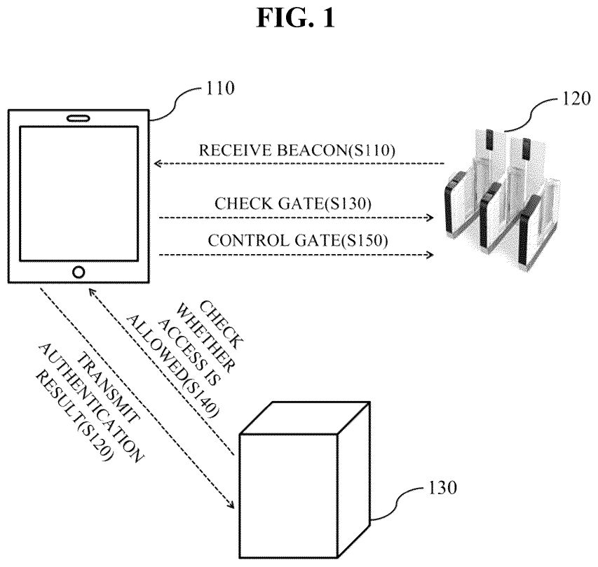

FIG. 1 is a diagram illustrating a method of authenticating gate access on the basis of a user terminal according to an embodiment of the present disclosure. Referring to FIG. 1, the method of authenticating gate access includes the following operations (S110 to S150).

In operation S110, a user terminal identifies gate devices provided in a plurality of gates using a beacon. The user terminal may transmit the beacon to surroundings at regular intervals to allow a gate device to receive the beacon or may receive a beacon transmitted from a gate device to thereby identify the gate device. Here, the user terminal may be a smart terminal possessed by a user. The gate device may be a terminal device capable of transmitting or receiving a beacon to or from a smart terminal or a device equipped with such a module separately.

The user terminal, in response to identifying at least one gate device, among the plurality of gate devices, which is located within an area in which a short-range wireless communication is available, activates an application for performing authentication using biometric information. The application may be installed by a user in advance or instantly installed in the field to communicate with the gate device. The gate device may transmit, to the user terminal, a Uniform Resource Locator (URL) to download the application when the application is not installed on the user terminal or may transmit the application directly through a short-range wireless communication.

In operation S120, the user terminal performs authentication using biometric information stored in advance and transmits a result of the authentication to an authentication server. In the user terminal, biometric information is stored before the user performs gate access. Here, the biometric information may be a user's face image and may be provided using unique information that may identify a user, such as an iris or fingerprint. The biometric information may be acquired using a camera or sensor included in the user terminal. For example, a face image of a user may be captured using the camera so that biometric information contained in the face image may be acquired.

On the other hand, in operation S120, the user terminal performs the following detailed operations. First, the user terminal performs an operation of storing biometric information in advance, then performs an operation of generating an authentication template using the biometric information, then performs an operation of capturing biometric information of the user in the field using an application, and then performs an operation of generating a temporary template using the captured biometric information, and then performs an operation of comparing the authentication template with the temporary template to perform authentication. The operations may be performed as a single process in operation S120, and the user terminal may directly perform authentication on the basis of the user's biometric information.

Here, the authentication may be performed by comparing the templates generated on the basis of two pieces of biometric information. For example, templates are generated using biometric information of the user stored in advance and biometric information instantly acquired and having the same type as the biometric information stored in advance, and the two templates are compared with each other so that authentication is performed. Here, the user terminal may perform the authentication by comparing the similarity of the template extracted on the basis of the biometric information. The template refers to a type of data of a feature that is extracted from biometric information and analyzed and stored. The data is encoded in a predetermined method and stored in the user terminal.

The user terminal may generate a template on the basis of the biometric information stored in advance and may generate a template according to the same process using biometric information acquired instantly. Preferably, the templates generated on the basis of the face image of the same user may be identical or have a high similarity, only with a difference in the time of generation. However, when capturing the face in practice, a feature point included in the face may not be accurately captured depending on the capturing angle or direction. Therefore, when templates are not perfectly identical but have a similarity greater than or equal to a level based on a criterion for determining the same user, the templates may serve as a basis on which the same user is identified. As described above, the user terminal may compare the similarity of the two templates, and when the similarity is greater than a reference value, identify that a user is the same user, and when the similarity is less than the reference value, identify that a user is another user. Such a biometric information-based authentication method is known in a large number of technologies, and through application or combination of the technologies, a user may be authenticated. Hereinafter, a template generated on the basis of biometric information stored in advance is referred as an authentication template, and a template generated using biometric information acquired on the spot is referred to as a temporary template.

On the other hand, the user terminal transmits the result of the authentication to the authentication server. That is, the subject that performs authentication is the user terminal, and the authentication server is provided to receive the result processed by the user terminal. Here, the authentication server may receive only the result of the authentication from the user terminal or may receive both the biometric information and the result of the authentication. The authentication server includes a database that stores the biometric information and the result of the authentication as data.

In operation S130, the user terminal checks the location of a specific gate for which access authorization is given among the plurality of gates. As described above, the plurality of gates are provided with gate devices, and the user is authorized to pass through a specific gate among the plurality of gates. Because a gate that a user needs to pass through in order to move to a specific route or platform on the basis of information issued in advance is specified, the user terminal checks the location of the specific gate for which access authorization is given. For example, the application installed on the user terminal may output information about the location of the gate for which access authorization is given, or the number of the specific gate on the screen of the user terminal. Therefore, the user is allowed to move to the location of the gate that the user is authorized to pass through on the basis of the information output on the screen.

On the other hand, according to one embodiment of the present disclosure, since biometric information-based authentication is achieved by comparing biometric information stored in the terminal with information acquired in the field, the authentication itself may succeed regardless of whether the user is allowed to access the gate. Therefore, according to operation S140, the authentication server checks whether access of the user is allowed. Here, the checking of whether access is allowable represents checking whether there is no problem even when the user enters into or departs from another country by passing through the gate and, for example, may represent retrieving access restriction information of a user and allowing or restricting gate access such that gate access is subject to strict processing. The authentication server includes a database that stores pieces of access restriction information about a plurality of users. The above-described database for storing the biometric information of the user and the result of the authentication may be used, or a separate database may be used for storing the access restriction information. The authentication server may, in response to the access restriction information of the user being retrieved in the database, transmit a notification according to access restriction to the user terminal.

On the other hand, the access restriction information includes at least one of a criminal record, a departure prohibition record, and an entry prohibition record for each of the plurality of users. The authentication server retrieves access restriction information of a user who has performed authentication using the database. When one of the pieces of access restriction information is retrieved, even the user who has been successful in authentication may be stopped from accessing the gate. That is, according to such a process, authentication is dually performed so that the gate access procedure of the user is strengthened. In the conventional technology, a user directly provides or inputs information about himself/herself through a plurality of procedures so that authentication for passing through a gate is performed in stages. The technology may provide the effect of strengthening security, but inconvenience of the user increases as security is strengthened. Accordingly, in order to ease the limitations, the disclosed technology doubly processes authentication without a user performing a separate input or procedure.

In operation S150, the user terminal receives a response indicating whether access is allowed from the authentication server. Then, the user terminal transmits a control signal to the gate device provided in the specific gate according to whether access is allowed. The user terminal is equipped with an application capable of short-range wireless communication with the gate device and may directly transmit the control signal using the application. Therefore, the user terminal may serve as the subject of the authentication and transmit a control signal for gate opening and closing.

On the other hand, the authentication server may receive, from the gate device, a response informing that the control signal has been received. For example, the gate device, upon receiving a control signal from the user terminal, may automatically transmit a signal, such as an acknowledgment (ACK), to the authentication server. Upon receiving the response according to the control signal, the authentication server may delete the data stored in the database. Alternatively, the authentication server, when a preset set time has elapsed using a timer, may automatically delete the result of the authentication received from the user terminal. As described above, the biometric information and the record of the authentication of the user are not kept but are discarded so that the authentication of the user may be processed without violating the biometric information protection guidelines.

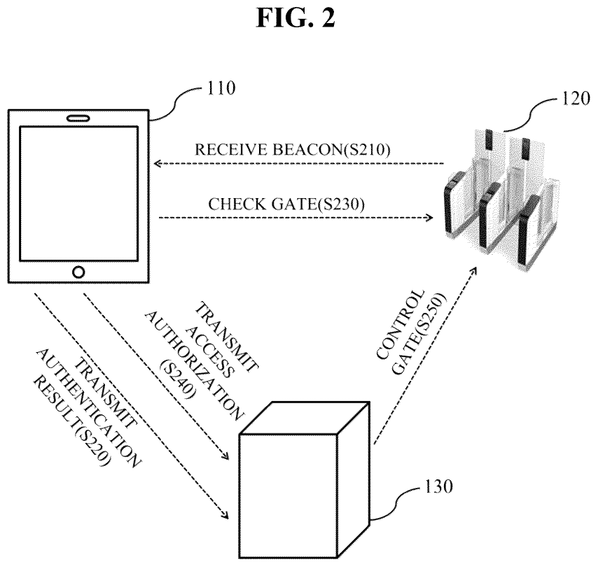

FIG. 2 is a diagram illustrating a method of authenticating gate access based on an authentication server according to an embodiment of the present disclosure. Referring to FIG. 2, a substantial subject for performing authentication is the authentication server, and the user terminal and the gate device may operate according to a result of the authentication of the authentication server.

In operation S210, the user terminal receives a beacon from at least one of the gate devices provided in each of the plurality of gates. The user terminal, upon identifying the gate device by receiving the beacon as described, activates an application according to operation S220. The application installed on the user terminal may be automatically executed when it is confirmed through a beacon that a gate device exists nearby. The user terminal is installed with an application for communication with the gate device in advance. The application may be automatically executed using a beacon as a trigger. The user terminal, upon identifying at least one gate device, among the plurality of gate devices, located within an area in which a short-range wireless communication is available, activates an application for performing authentication using biometric information.

On the other hand, in operation S220, the user terminal captures a face image of a user according to the executed application, then generates a temporary template on the basis of the face image, and then compares the temporary template with the template stored in advance to perform authentication. The method and process of generating the two templates may be the same as those described above.

On the other hand, in operation S230, the user terminal checks the location of a specific gate for which access authorization is given among the plurality of gates depending on the result of the authentication. For example, when the authentication succeeds, the application may load ticketing information of the user to check the location of a specific gate for which access authorization is given. The application may not only be provided for communication with the gate device but may also be integrated with an application that may process ticketing of the user in advance. Therefore, the user terminal may operate to store ticketing information of the user processed through the application, and when authentication succeeds, acquire an authorization to access the ticketing information to check the location of the specific gate.

On the other hand, when the checking of the location of the gate is completed, the user terminal transmits the result of the authentication and the information about the access authorization to the authentication server. The result of the authentication transmitted by the user terminal may be information indicating that the authentication succeeds, and the information about the access authorization refers to information indicating a gate that the user is allowed to pass through. Upon succeeding in authentication and checking the location of the gate, the user terminal transmits the result of the authentication and the information about the access authorization stored in advance to the authentication server.

Meanwhile, the authentication server includes a database that stores the result of the authorization and the information about the access authorization as data. The authentication server checks whether access of the user of the user terminal is allowed on the basis of the result of the authentication stored in the database according to operation S250. For example, the authentication server may retrieve access restriction information of the user to check whether access is allowed. The access restriction information includes at least one of a criminal record, a departure prohibition record, and an entry prohibition record for each of the plurality of users, and the authentication server includes a database that stores access restriction information of a plurality of users. Then the authentication server determines whether the user is a person for whom access is allowed by retrieving the access restriction information of the user using the database.

On the other hand, when the user is identified as a person for whom access is allowed, the authentication server transmits a control signal to the specific gate according to operation S260. In the embodiment described above with reference to FIG. 1, the user terminal directly transmits a control signal through an application, but in the present embodiment, the authentication server receives authentication-related information from the user terminal and determines whether the user is a user for whom access is allowed, and transmits a control signal to the gate.

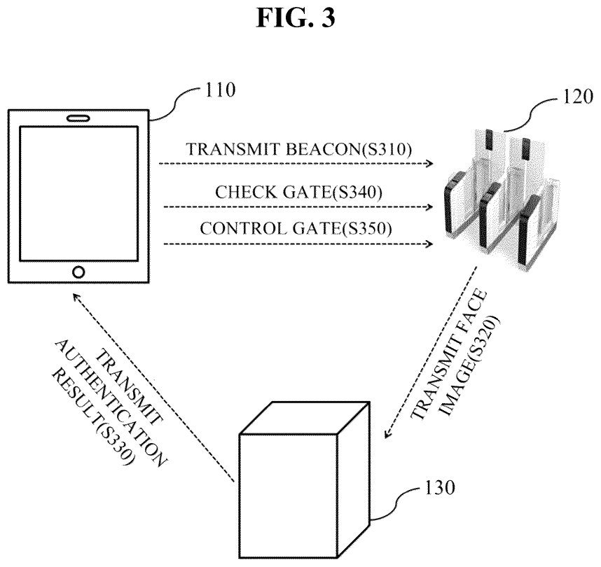

FIG. 3 is a diagram illustrating a method of authenticating gate access based on a gate device and an authentication server according to an embodiment of the present disclosure. Referring to FIG. 3, the method of authenticating gate access may be performed by setting the subject that generates a temporary template as a gate device and setting the subject that performs authentication as an authentication server.

First, according to operation S310, the user terminal transmits a beacon to some gate devices among a plurality of gate devices provided at a plurality of gates, the some gate devices being located within an area in which short-range wireless communication is available. Then, according to operation S320, an environment in which communication with a gate device at a location most adjacent to the user terminal among the some gate devices may be created. For example, a Bluetooth pairing for transmitting/receiving a signal between the user terminal and the specific gate device may be performed.

On the other hand, in operation S320, the gate device pairing with the user terminal drives a camera according to the beacon to capture a face image of the user. The gate device may also be installed with an application that is driven using a beacon as a trigger in the same manner as the user terminal. When capturing the face image of the user using the camera, in order to capture the accurate face image, the gate device may perform an addition operation of allowing the user to move to a correct position. For example, the user may be allowed to come closer or guided to a capturing position indicated on the floor in front of the gate through speech.

Meanwhile, in operation S330, the authentication server receives a face image of the user from the specific gate device. The authentication server and the gate device are connected to each other in advance in a wired or wireless manner, and the gate device may transmit the face image to the authentication server according to the connected communication method. The authentication server performs authentication by comparing the face image with pieces of biometric information of a plurality of users registered in the database and checks whether access of the user is allowed according to a result of the authentication. The authentication performed in operation S330 may also be performed by comparing a template generated on the basis of the face image of the user. That is, the authentication server may generate a temporary template using the face image captured by the gate device, and perform authentication by comparing the temporary template with a plurality of authentication templates generated on the basis of the plurality of pieces of biometric information stored in the database in advance. When the same user has a face image captured normally, a chance of succeeding in authentication is higher. However, when an inaccurate face image is captured or a different user is captured, authentication may fail. In this case, the authentication server may transmit a control signal to the gate device to re-capture the face image of the user. The number of times the face image is re-captured may be limited to maintain security.

On the other hand, the authentication server may check whether access of the user is allowed by retrieving access restriction information of the user. As described above, the authentication server may determine whether access of the user is allowed by searching a database that stores access restriction information.

On the other hand, in operation S340, the user terminal receives a response indicating a result of the authentication and whether access is allowed from the authentication server. Unlike the embodiment described with reference to FIGS. 1 and 2, the authentication server serves as a subject of authentication, and the user terminal receives the result of the authentication from the authentication server. When the user is a legitimate user, authentication may be performed normally through the authentication server. When it is checked through the authentication server that the authentication succeeds, the user terminal checks the location of a specific gate for which access authorization is given among a plurality of gates according to operation S340. Here, the gate device having captured the face image of the user and the gate device provided in the specific gate for which access authorization is given may be the same or different. That is, the method operates such that, when the user is located adjacent to a gate, the face is captured through the most adjacent gate for the convenience of the user, and a gate for which access authorization is given to allow the user to pass therethrough may be a different gate. Accordingly, the user terminal checks the location of the specific gate for which the access authorization is given according to operation S340. In operation S350, the user terminal transmits a control signal to a gate device provided in the specific gate.

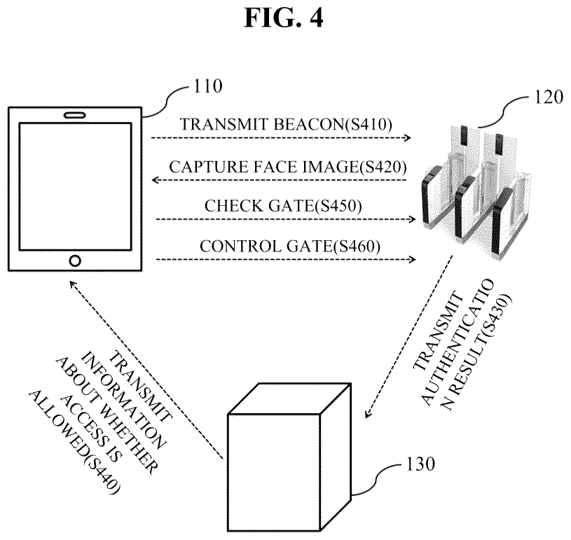

FIG. 4 is a diagram illustrating a method of authenticating gate access based on a gate device according to an embodiment of the present disclosure. Referring to FIG. 4, the gate device may perform primary authentication using a face image of a user, and the authentication server may perform secondary authentication.

In operation S410, the user terminal transmits a beacon to some gate devices located within an area in which short-range wireless communication is available among gate devices provided at a plurality of gates. In one embodiment, a beacon may be transmitted to gate devices located within an area in which Bluetooth communication is available.

In operation S420, a specific gate device located most adjacent to the user terminal among the some gate devices drives a camera. As described above with reference to FIGS. 1 to 3, an application installed on the gate device is driven according to the beacon to control the camera so that the face image of the user is captured. Here, the most adjacent gate device is simply determined according to the order of smallest distance to the user terminal to perform most stable communication with the user terminal among the plurality of gate devices. Since short range wireless communication, such as Bluetooth, has a greater strength at a closer distance between terminals, the specific gate device may be selected based on the distance from the user terminal rather than a separate priority. The gate device selected as described above may capture the face image of the user.

In operation S430, the specific gate device that has captured the face image of the user generates a temporary template using the face image of the user. Then, the specific gate device performs authentication by comparing the generated temporary template with a plurality of authentication templates generated on the basis of a plurality of pieces of biometric information stored in advance. The temporary template is generated on the basis of a face image captured on the spot for gate access. The authentication templates are stored by the gate device through a predetermined registration procedure in advance. The gate device may perform authentication by comparing the similarity between the two templates.

Meanwhile, in operation S440, the authentication server receives a result of the authentication from the specific gate device. The result of the authentication may be an authentication success or authentication failure. Preferably, the authentication server, upon receiving the result of the authentication, checks whether access of the user is allowed. Whether access of the user is allowed may be checked by inquiring about a plurality of pieces of access restriction information of a plurality of users stored in a database. The authentication server may determine that a user, about which access restriction information is not inquired, is granted access. The access restriction information includes at least one of a criminal record, a departure prohibition record, and an entry prohibition record for each of the plurality of users. A user for which a departure/entry prohibition record or a crime record exists may be determined as not being granted access. In this case, the authentication server transmits a notification according to the access restriction to the user terminal.

On the other hand, the authentication server, after the transmission of the result of the authentication and information about whether access is allowed or when a preset time has elapsed after the transmission, deletes the result of the authentication and the information about whether access is allowed. That is, data regarding biometric information-based authentication of the user is discarded rather than being stored.

In operation S450, the user terminal receives a response indicating the result of the authentication and the information about whether access is allowed from the authentication server and checks the location of a specific gate for which access authorization is granted among the plurality of gates. The location of the gate may be checked on the basis of ticketing information. The user terminal may receive a response indicating the result of the authentication of the gate device and the result of whether access is allowed, through the authentication server. Upon the two authentications being successful, the user terminal transmits a control signal to the gate device provided in the specific gate according to operation S450.

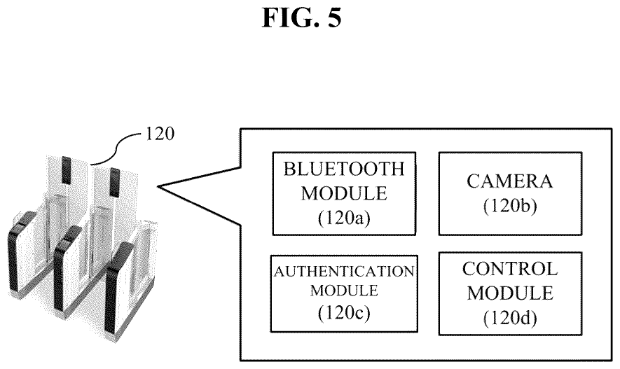

FIG. 5 is a diagram illustrating an apparatus for authenticating gate access according to an embodiment of the present disclosure. Referring to FIG. 5, the apparatus for authenticating gate access includes a Bluetooth module, a camera, an authentication module, and a control module. The apparatus for authenticating gate access may be a gate device provided in a gate, and as needed, the user terminal or the authentication server may serve as the apparatus for authenticating gate access.

The Bluetooth module transmits a beacon at regular intervals to detect a user terminal approaching an area in which communication is available. The Bluetooth module may identify the location of the user terminal using a beacon. The apparatus for authenticating gate access, upon checking that the Bluetooth module has detected a user terminal, may initialize the camera to capture the user.

The camera performs capturing when the user of the user terminal approaches an area in which capturing is performable. The camera captures the face image of the user. In order to accurately acquire information indicating biometric characteristics included in the face image, the camera may acquire the image by capturing the front of the face of the user. To this end, a position or point at which camera capturing is smoothly performable may be determined in advance.

The authentication module receives the face image of the user captured by the camera. Then, the authentication module generates a template on the basis of the face image. The face image of the user is a face image captured instantly in the field provided with a gate, and a template generated using the face image serves as a temporary template.

On the other hand, the authentication module includes a database for storing a plurality of templates of a plurality of users in advance, and the templates stored in advance are used as information for being compared with a temporary template to perform authentication. As described above with reference to FIGS. 1 to 4, the template acquired instantly in the field is referred to as a temporary template, and the plurality of templates of the plurality of users stored in advance are referred to as authentication templates. The authentication module may compare the two templates to find one of the plurality of authentication templates that matches the temporary template. The authentication module authenticates the user according to the process.

On the other hand, the authentication module also stores access restriction information of the plurality of users in the database. In addition, when access restriction information of the user is retrieved from the database, the authentication module may transmit a notification according to access restriction to the user terminal. For example, when the authentication for the user succeeds, a process of retrieving access restriction information may be performed, and when the authentication for the user fails, re-authentication may be performed instead of retrieving the access restriction information. In the database of the authentication module, at least one of a criminal record, a departure prohibition record, and an entry prohibition record for each of the plurality of users is recorded. The authentication module, after primary authentication on the user, may perform the secondary authentication by retrieving the access restriction information.

On the other hand, the authentication module, after the two-stage authentication on the user according to the above-described process, transmits the authentication result of the gate control module. Then, the authentication module deletes the face image, the template, and the authentication result of the user from the database.

The gate control module opens the gate according to the authentication result received from the authentication module. When the authentication module succeeds in authentication, the gate control module may transmit a control signal to the gate to open the gate. When the authentication module fails in authentication, the camera may re-capture the face image of the user rather than opening the gate.

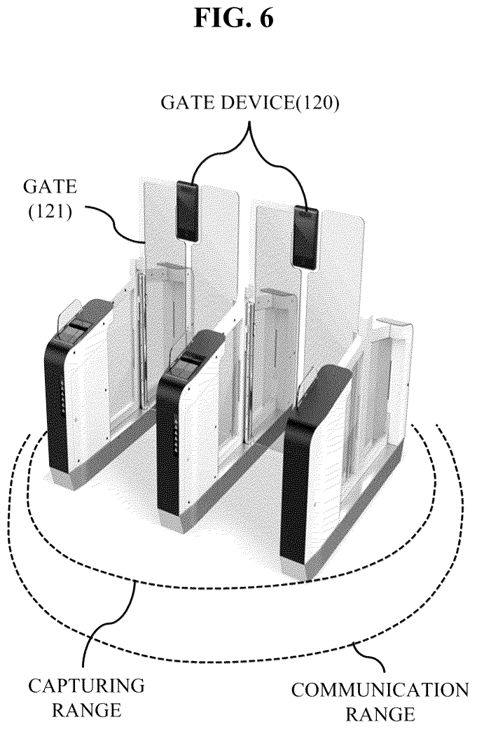

FIG. 6 is a diagram illustrating gate devices provided in gates. Referring to FIG. 6, a gate device may be provided in each gate. The gate device provided in each gate is provided with a camera for capturing the face of a user accessing a surrounding of the gate device. In order to more accurately identify biometric information contained in the user's face, the camera may be disposed at the center of the gate. The gate may have a structure that slides to the left and right sides and opens, and a space in which the gate device may be arranged in an area that faces the gate such that the gate device may be placed in front of the gate. The gate device may be a device that is equipped with a camera, and as needed, the gate device may have only the camera arranged in front of the gate, and the remaining devices, except the camera, inserted into a periphery of the gate or a structure to which the gate is fixed.

On the other hand, the gate device may identify a user terminal possessed by the user using a beacon and capture a face image of the user using the camera. The gate device may transmit a beacon to the user terminal or receive a beacon from the user terminal and have a set range in which communication is available in a wireless manner through the beacon. For example, a communication range capable of communicating through Bluetooth may be set. In general, in the case of Bluetooth low energy (BLE)-based communication, a communication range of about 50 meters is formed, and the gate device may also be set to have a communication range approximating or matching 50 meters.

On the other hand, the gate device may also have a set range in which the face image of the user is captured. For example, a predetermined capturing range may be set for the user to be positioned at a distance in which feature information included in the user's face is accurately identified. In general, the communication range is formed to be wider than the capturing range, and thus the capturing range and the communication range may be different from each other as shown in FIG. 6. However, the capturing range and the communication range may be set to be the same by limiting the communication sensitivity or scope of a Bluetooth module, or installing a high-performance camera. With such a setting, the user, who is approaching the gate by a certain amount or more, may perform authentication in place without moving. In this case, since the application is automatically activated and the authentication process is performed without touching the gate device with a hand or inputting a separate input to his/her terminal, the gate access may be achieved without inconvenience in the authentication process.

Although the method and apparatus for authenticating gate access according to embodiments of the present disclosure have been described with reference to the embodiments shown in the drawings, the above embodiments should be regarded as illustrative, and a person of ordinary skill in the art should appreciate that various modifications and equivalents derived from the teaching and suggestion of the above specification fall within the scope and sprit of the present disclosure. Therefore, the scope of the present disclosure is defined by the appended claims of the present disclosure.

1. A method of authenticating gate access, the method comprising:
identifying, by a user terminal, gate devices provided in a plurality of gates using a beacon;
performing, by the user terminal, authentication using biometric information stored in advance and transmitting a result of the authentication to an authentication server;
checking, by the user terminal, a location of a specific gate for which access authorization is given among the plurality of gates;
receiving, by the authentication server, the result of the authentication and checking whether access of a user of the user terminal is allowed; and
transmitting, by the user terminal, a control signal to a gate device provided in the specific gate according to whether the access is allowed.

2. The method of claim 1, wherein the user terminal activates an application for performing the authentication using the biometric information in response to identifying at least one gate device located within an area in which short-range wireless communication is available among the plurality of gate devices.

3. The method of claim 1, wherein the transmitting of the result of the authentication to the authentication server includes:
storing, by the user terminal, the biometric information in advance;
generating, by the user terminal, an authentication template using the biometric information;
capturing, by the user terminal, biometric information of the user in a field using an application;
generating a temporary template using the captured biometric information; and
comparing the authentication template with the temporary template to perform the authentication.

4. The method of claim 1, wherein the authentication server includes a database for storing the biometric information and the result of the authentication as data and, in response to receiving, from the gate device, a response indicating that the control signal has been received by the gate device, deletes the data stored in the database.

5. The method of claim 1, wherein the authentication server automatically deletes the result of the authentication received from the user terminal when a preset time has elapsed.

6. The method of claim 1, wherein the biometric information includes feature information extracted from a face image of the user.

7. The method of claim 1, wherein the checking, by the user terminal, of the location of the specific gate includes outputting, by the user terminal, information about the location of the specific gate on a screen on the basis of pre-stored ticketing information.

8. The method of claim 1, wherein the authentication server includes a database for storing access restriction information for a plurality of users and, in response to access restriction information of the user being retrieved in the database, transmits a notification according to the access restriction to the user terminal.

9. The method of claim 8, wherein the access restriction information includes at least one of a criminal record, a departure prohibition record, and an entry prohibition record for each of the plurality of users.

10. A method of authenticating gate access, the method comprising:
receiving, by a user terminal, a beacon from at least one of a plurality of gate devices provided in a plurality of gates;
in response to the beacon being received, activating, by the user terminal, an application to capture a face image of a user, generating a temporary template on the basis of the face image, and comparing the temporary template with an authentication template stored in advance to perform authentication;
checking, by the user terminal, a location of a specific gate, for which access authorization is given among the plurality of gates, according to a result of the authentication;
transmitting, by the user terminal, the result of the authentication and information about the access authorization to the authentication server;
checking, by the authentication server, whether access of a user of the user terminal is allowed on the basis of the result of the authentication; and
transmitting, by the authentication server, a control signal to the specific gate according to a result of the checking of whether access is allowed and the information about the access authorization.

11. The method of claim 10, wherein the user terminal activates an application for performing the authentication using biometric information in response to identifying at least one gate device located within an area in which short-range wireless communication is available among the plurality of gate devices.

12. The method of claim 10, wherein the authentication server includes a database for storing the result of the authentication and the information about the access authorization as data and, after transmitting the control signal, deletes the data stored in the database.

13. The method of claim 10, wherein the checking, by the user terminal, of the location of the specific gate includes outputting, by the user terminal, information about the location of the specific gate on a screen on the basis of pre-stored ticketing information.

14. The method of claim 10, wherein the checking, by the authentication server, of whether access is allowed includes:
retrieving access restriction information of the user using a database for storing access restriction information for a plurality of users and, in response to the access restriction information being not retrieved, transmitting the control signal and, in response to the access restriction information being retrieved, transmitting a notification according to the access restriction to the user terminal.

15. The method of claim 14, wherein the database includes at least one of a criminal record, a departure prohibition record, and an entry prohibition record for each of the plurality of users.

16. A method of authenticating gate access, the method comprising:
transmitting, by a user terminal, a beacon to some gate devices of a plurality of gate devices provided in a plurality of gates, the some gate devices being located within an area in which short-range wireless communication is available;
driving, by a specific gate device located most adjacent to the user terminal among the some gate devices, a camera according to the beacon to capture a face image of a user;
receiving, by the authentication server, the face image from the specific gate device, and comparing the face image with pieces of biometric information of a plurality of users registered in a database to perform authentication, and checking whether access of the user is allowed according to a result of the authentication;
receiving, by the user terminal, a response indicating the result of the authentication and information about whether the access is allowed from the authentication server, and checking a location of a specific gate for which access authorization is given among the plurality of gates; and
transmitting, by the user terminal, a control signal to a gate device provided in the specific gate.

17. The method of claim 16, wherein the performing of the authentication includes:
generating, by the authentication server, a temporary template using the face image; and
comparing the temporary template with a plurality of authentication templates generated on the basis of the pieces of biometric information stored in the database.

18. The method of claim 16, wherein the checking, by the user terminal, of the location of the specific gate includes outputting, by the user terminal, information about the location of the specific gate on a screen on the basis of pre-stored ticketing information.

19. The method of claim 16, wherein the checking of whether access of the user is allowed includes, in response to the authentication succeeding, inquiring, by the authentication server, at least one of a criminal record, a departure prohibition record, and an entry prohibition record for each of the plurality of users that are stored in the database and determining whether access is allowed.

20. The method of claim 16, wherein the checking of whether access of the user is allowed includes, in response to the authentication failing, transmitting, by the authentication server, a control signal to the specific gate device to re-capture the face image of the user.

21. A method of authenticating gate access, the method comprising:
transmitting, by a user terminal, a beacon to some gate devices among a plurality of gate devices provided in a plurality of gates, the some gate devices being located within an area in which short-range wireless communication is available;
driving, by a specific gate device located most adjacent to the user terminal among the some gate devices, a camera according to the beacon to capture a face image of a user;
generating, by the specific gate device, a temporary template using the face image of the user, and comparing the temporary template with a plurality of authentication templates generated on the basis of pieces of biometric information stored in advance to perform authentication;
receiving, by an authentication server, a result of the authentication from the specific gate device to check whether access of the user is allowed;
receiving, by the user terminal, a response indicating the result of the authentication and information about whether access of the user is allowed from the authentication server, and checking a location of a specific gate for which access authorization is given among the plurality of gates; and
transmitting, by the user terminal, a control signal to a gate device provided in the specific gate.

22. The method of claim 21, wherein the authentication server includes a database for storing the result of the authentication and the information about whether the access is allowed, and after transmitting the result of the authentication and the information about whether the access is allowed to the user terminal, deletes the result of the authentication and the information about whether the access is allowed.

23. The method of claim 21, wherein the authentication server, when a preset time has elapsed since the transmitting of the result of the authentication and the information about whether the access is allowed to the user terminal, automatically deletes the result of the authentication and the information about whether the access is allowed that have been transmitted to the user terminal.

24. The method of claim 21, wherein the checking, by the user terminal, of the location of the specific gate includes outputting, by the user terminal, information about the location of the specific gate on a screen on the basis of pre-stored ticketing information.

25. The method of claim 21, wherein the checking of whether access is allowed includes determining, by the authentication sever, whether the access of the user is allowed using access restriction information about a plurality of users stored in a database.

26. The method of claim 25, wherein the authentication server, in response to access restriction information of the user being retrieved, transmits a notification according to the access restriction to the user terminal.

27. The method of claim 26, wherein the access restriction information includes at least one of a criminal record, a departure prohibition record, and an entry prohibition record for each of the plurality of users.

28. An apparatus for authenticating gate access, the apparatus comprising:
a Bluetooth module configured to transmit a beacon at equal intervals to detect a user terminal that approaches an area in which communication is available;
a camera configured to, in response to a user of the user terminal approaching an area in which capturing is performable, capture a face image of the user;
an authentication module configured to generate a template on the basis of the face image and compare the template with a plurality of templates of a plurality of users stored in advance to perform authentication on the user; and
a gate control module configured to open a gate according to a result of the authentication received from the authentication module.

29. The apparatus of claim 28, wherein the authentication module includes a database for storing the plurality of templates and compares the template of the user with the plurality of templates to identify whether the template of the user matches one of the plurality of templates to perform the authentication.

30. The apparatus of claim 28, wherein the authentication module stores access restriction information for the plurality of users in a database and, in response to access restriction information of the user being retrieved from the database, transmits a notification according to the access restriction to the user terminal.

31. The apparatus of claim 30, wherein the access restriction information includes at least one of a criminal record, a departure prohibition record, and an entry prohibition record for each of the plurality of users.

32. The apparatus of claim 28, wherein the authentication module, after transmitting the result of the authentication to the gate control module, deletes the face image of the user, the temple of the user, and the result of the authentication.
